(19) United States
(12) Patent Application Publication
(10) Pub. No.: US 2026/0242887 A1
(43) Pub. Date: Aug. 20, 2026

(54) High-magnetic-induction grain-oriented silicon steel and preparation method thereof

(71) Applicant: SHOUGANG ZHIXIN ELECTROMAGNETIC MATERIALS (QIAN'AN) CO., LTD., Tangshan (CN)

(72) Inventors: Liangying SI, Tangshan (CN); Jiaji MA, Tangshan (CN); Maolin SUN, Tangshan (CN); Jian GONG, Tangshan (CN); Songshan ZHAO, Tangshan (CN); Xuechang YOU, Tangshan (CN); Xianhui WANG, Tangshan (CN); Ruifeng LI, Tangshan (CN); Weiguang PANG, Tangshan (CN); Haichao LIU, Tangshan (CN); Huiming XIAO, Tangshan (CN); Jianhui TIAN, Tangshan (CN); Haibin YU, Tangshan (CN); Lei LIU, Tangshan (CN)

(73) Assignee: SHOUGANG ZHIXIN ELECTROMAGNETIC MATERIALS (QIAN'AN) CO., LTD., Tangshan, HE (CN)

(21) Appl. No.: 19/644,227

(22) Filed: Apr. 10, 2026

Related U.S. Application Data
(63) Continuation of application No. PCT/CN2024/083083, filed on Mar. 21, 2024.

(30) Foreign Application Priority Data
Mar. 23, 2023 (CN) 202310288691.9

(51) Int. Cl. C21D 9/52; C21D 1/28; C21D 6/00; C21D 8/1216; C21D 8/1244; C22C 38/00; C22C 38/02; C22C 38/04; C22C 38/06; C22C 38/20; C22C 38/22; C22C 38/24; C22C 38/26; C22C 38/28; C22C 38/32; C22C 38/34; C23C 8/26; H01F 1/147

(52) U.S. Cl. CPC C21D 9/52; C21D 1/28; C21D 6/002; C21D 6/005; C21D 6/008; C21D 8/1222; C21D 8/1233; C21D 8/1255; C21D 8/1261; C22C 38/001; C22C 38/002; C22C 38/008; C22C 38/02; C22C 38/04; C22C 38/06; C22C 38/20; C22C 38/22; C22C 38/24; C22C 38/26; C22C 38/28; C22C 38/32; C22C 38/34; C23C 8/26; H01F 1/14775; C21D 2201/05; C22C 2202/02

(57) ABSTRACT

Disclosed are a high-magnetic-induction grain-oriented silicon steel and a preparation method thereof. The preparation method comprises the following steps: heating a hot-rolled strip steel and then subjecting the same to a cold continuous rolling by using a cold continuous rolling mill with work-roll diameters ranging from 300 mm to 500 mm, to obtain a cold continuous rolled strip steel; and sequentially subjecting the cold continuous rolled strip steel to a decarburization and nitriding, to obtain the high-magnetic-induction grain-oriented silicon steel.

### CROSS-REFERENCE TO RELATED APPLICATIONS

This is a continuation of International Application No. PCT/CN2024/083083, filed on Mar. 21, 2024, which claims priority to Chinese Patent Application No. 202310288691.9, filed on Mar. 23, 2023. The disclosures of the above-referenced applications are hereby incorporated by reference in their entireties.

### TECHNICAL FIELD

The disclosure relates to the technical field of cold rolling of grain-oriented silicon steel, and in particular to a high-magnetic-induction grain-oriented silicon steel and preparation method thereof.

### BACKGROUND

A grain-oriented silicon steel is an excellent soft magnetic material, mainly used for manufacturing electromagnetic equipment such as transformers and reactors. The grain-oriented silicon steel is classified into a high-magnetic-induction grain-oriented silicon steel and a conventional grain-oriented silicon steel according to magnetic performance. A grain-oriented silicon steel with a magnetic induction higher than 1.88 T at 800 A/m is a high-magnetic-induction grain-oriented silicon steel, and a grain-oriented silicon steel with a magnetic induction not exceeding 1.88 T is a conventional grain-oriented silicon steel. In China and abroad, the high-magnetic-induction grain-oriented silicon steel is generally rolled by a twenty-high reversible rolling mill, which has a low rolling efficiency due to difficulties in two aspects including easy strip breakage during rolling and deterioration of electromagnetic performance.

In the related art, there is still room for improvement in the electromagnetic performance of the high-magnetic-induction grain-oriented silicon steel rolled by the twenty-high reversible rolling mill.

### SUMMARY

A technical problem of relatively high iron loss and relatively low magnetic performance of a high-magnetic-induction grain-oriented silicon steel is solved by using one or more embodiments of the disclosure.

According to an aspect of the disclosure, a method for preparing high-magnetic-induction grain-oriented silicon steel is provided, comprising the steps: heating a hot-rolled strip steel and then subjecting the same to a cold continuous rolling by using a cold continuous rolling mill with work-roll diameters ranging from 300 mm to 500 mm, to obtain a cold continuous rolled strip steel; and sequentially subjecting the cold continuous rolled strip steel to decarburization, nitriding and annealing, to obtain a high-magnetic-induction grain-oriented silicon steel.

According to another aspect of the disclosure, a high-magnetic-induction grain-oriented silicon steel is provided, which is prepared by the aforementioned preparation method.

### BRIEF DESCRIPTION OF DRAWINGS

FIG. 1 shows a process step diagram of a method for preparing high-magnetic-induction grain-oriented silicon steel according to some embodiments of the disclosure.

### DETAILED DESCRIPTION

To enable those skilled in the art to which the disclosure pertains to more clearly understand the disclosure, the content of the disclosure will be described in detail through specific embodiments with reference to the accompanying drawings.

In an aspect, a method for preparing high-magnetic-induction grain-oriented silicon steel according to some embodiments of the disclosure is provided. The high-magnetic-induction grain-oriented silicon steel is produced by a cold continuous rolling process, and a cold continuous rolling mill used has a large work-roll diameter, thereby reducing the iron loss of the high-magnetic-induction grain-oriented silicon steel and improving the magnetic performance of the finished grain-oriented silicon steel.

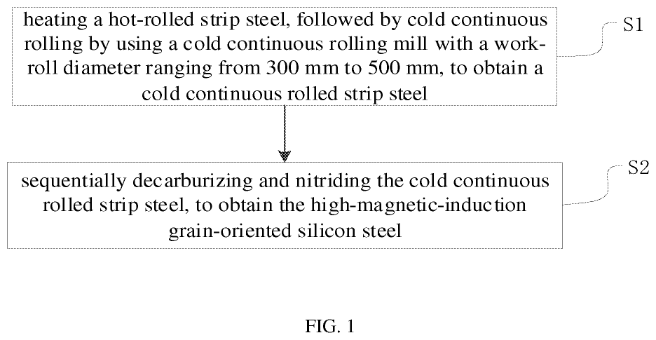

As shown in FIG. 1, the method for preparing high-magnetic-induction grain-oriented silicon steel according to some embodiments of the disclosure includes Step S1 and Step S2.

In Step S1, a hot-rolled strip steel is heated and then cold continuous rolled by using a cold continuous rolling mill with a work-roll diameter ranging from 300 mm to 500 mm, to obtain a cold continuous rolled strip steel.

In the disclosure, a cold rolling process can adopt cold continuous rolling by using the cold continuous rolling mill, to achieve a high production efficiency. A work-roll diameter of the cold continuous rolling mill reaches 300 mm to 500 mm, which is at least twice that of a twenty-high reversible rolling mill with a roll diameter not exceeding 150 mm, thereby achieving a long roll change cycle and high efficient preparation of high-magnetic-induction grain-oriented silicon steel. Meanwhile, a rolling deformation zone of the strip steel formed by rolling the strip steel with large-size work rolls is closer to that of flat rolling. Compared with rolling with a small-diameter work roll, the strip steel of the disclosure undergoes deformation closer to compression deformation, so that a large amount of shear deformation is formed in a central layer of the strip steel. The shear deformation in the central layer serves as nucleation sites to facilitate a primary recrystallization, so that the total amount of Goss grains in a thickness direction of the strip steel is increased. Thus, a growth of other grains can be inhibited during secondary recrystallization, so that a grain size of the grain-oriented silicon steel is relatively small, while the Goss grains can grow up, thereby improving a magnetic performance of the grain-oriented silicon steel. The cold continuous rolling mill may be a five-stand cold continuous rolling mill, a six-stand cold continuous rolling mill or a seven-stand cold continuous rolling mill, which is not specifically limited. In some embodiments, the cold continuous rolling mill is a six-stand cold continuous rolling mill.

The hot-rolled strip steel can be produced by a hot continuous rolling. A slab is heated to be a temperature of 1070° C. to 1180° C., held for 60 min to 200 min, and then fed into a hot rolling mill for hot rolling. During the hot rolling, a finishing rolling temperature ranges from 930° C. to 980° C., and a thickness of the hot-rolled strip steel may range from 1.8 mm to 3.0 mm. A laminar cooling may be adopted during the hot rolling, and a coiling temperature is controlled to range from 500° C. to 650° C.

In some embodiments, the hot-rolled strip steel is a strip steel normalized, that is, the hot-rolled strip steel is subjected to a normalizing treatment. In the normalizing treatment, a heating temperature of the strip steel ranges from 950° C. to 1200° C., and a soaking temperature of the strip steel ranges from 850° C. to 1000° C.; an average grain size of the strip steel after the normalizing treatment ranges from 30 μm to 50 μm.

In other embodiments, a normalized and annealed strip steel may be further subjected to a pickling, where a removal rate of an iron oxide scale after pickling is above 90%, and a surface roughness of the hot-rolled strip steel ranges from 2 μm to 8 μm, that is, a surface roughness of the strip steel at an inlet of the cold continuous rolling mill ranges from 2 μm to 8 μm. In some embodiments, a surface roughness of the hot-rolled strip steel may range from 3 μm to 8 μm. The pickled strip steel is then subjected to the cold continuous rolling.

In some embodiments, a total reduction rate of the cold continuous rolling ranges from 85% to 92%. When a six-stand cold continuous rolling mill is adopted, a reduction rate of each stand along a rolling direction may range from 25% to 45%, 25% to 45%, 25% to 45%, 10% to 35%, 10% to 35% and 10% to 35% in sequence.

In the cold continuous rolling, an excessively high total reduction rate will not only increase a rolling difficulty and a risk of strip breakage, but also reduce a favorable {111}texture to a certain extent, thereby decreasing a magnetic performance of the finished grain-oriented silicon steel. An excessively low total reduction rate means that a raw material coil, i.e., the hot-rolled strip steel, has a thinner thickness if the finished grain-oriented silicon steel with a target specification is to be obtained, which will not only increase a difficulty of hot rolling, but also reduce a cold rolling deformation stored energy, resulting in an uneven primary recrystallization to a certain extent and reducing a uniformity of magnetic performance. In some embodiments, a rolling speed of the cold continuous rolling ranges from 300 mpm to 1200 mpm; surface roughnesses of work rolls of the cold continuous rolling mill range from 0.1 μm to 0.8 μm.

Controlling a rolling speed of the cold continuous rolling can improve a production efficiency of the grain-oriented silicon steel on the premise of no strip breakage. In some embodiments, a rolling speed at an outlet of the cold continuous rolling mill ranges from 850 mpm to 1100 mpm. In some embodiments, a rolling speed ranges from 900 mpm to 1000 mpm, where mpm represents m/min, that is, a running distance of the strip steel per minute. A surface roughness of the work rolls of the cold continuous rolling mill is controlled to be 0.1 μm to 0.8 μm. In some embodiments, when a six-stand cold continuous rolling mill is adopted, a surface roughness of the work rolls along the rolling direction may range from 0.4 μm to 0.8 μm, 0.4 μm to 0.8 μm, 0.4 μm to 0.8 μm, 0.4 μm to 0.6 μm, 0.1 μm to 0.3 μm and 0.1 μm to 0.3 μm in sequence.

In some embodiments, a rolling temperature of the cold continuous rolling ranges from 70° C. to 300° C. Since a high-magnetic-induction grain-oriented silicon steel has a poor plasticity, a high deformation resistance and a large rolling force, and is prone to strip breakage, controlling a temperature of the cold continuous rolling can improve a plasticity of the strip steel and thus avoid the occurrence of strip breakage during the cold continuous rolling. An excessively high rolling temperature will affect a lubrication effect of emulsion to a certain extent, and reduce a surface quality and a rolling stability of the grain-oriented silicon steel. An excessively low rolling temperature will affect a plasticity of the strip steel to a certain extent, easily leading to strip breakage. A rolling temperature of the cold continuous rolling can be achieved by heating before the cold continuous rolling. A manner of heating may be electromagnetic heating or other manners for heating, which is not limited in the disclosure.

In some embodiments, a surface roughness of the cold continuous rolled strip steel ranges from 0.1 μm to 0.5 μm. The surface roughness of the cold continuous rolled strip steel has a certain impact not only on a surface quality, but also on decarburization and nitriding in a subsequent annealing process. An excessively high surface roughness will cause a decline in a surface quality of the grain-oriented silicon steel to a certain extent, and at the same time, an uneven surface of the grain-oriented silicon steel adds an additional barrier to a recrystallization of the surface layer, easily leading to fine grains. An excessively low surface roughness will reduce a specific surface area to a certain extent, affect an efficiency of decarburization and nitriding, and also affect a pinning effect of the bottom layer to a certain extent, thereby reducing an adhesion of the bottom layer, increasing an iron loss, and reducing a magnetic performance of the high-magnetic-induction grain-oriented silicon steel.

In Step S2, the cold continuous rolled strip steel is sequentially subjected to a decarburization and a nitriding to obtain the high-magnetic-induction grain-oriented silicon steel.

A function of the decarburization annealing is to reduce the carbon content in the grain-oriented silicon steel, so as to prevent a problem that the magnetic performance is deteriorated due to an aging of carbon atoms during a long-term service of power devices made of the grain-oriented silicon steel. In the disclosure, decarburization is performed after cold rolling instead of controlling the carbon content during steelmaking, because the carbon content has, before a decarburization annealing, a function of adjusting an austenite ratio during hot rolling and normalizing. The inhibitor has a high solid solubility in austenite than that in the ferrite. Therefore, when the austenite is formed at a high temperature, the inhibitor can be firstly dissolved in the austenite and then precipitated from the austenite during cooling to form a dispersedly distributed inhibitor. The dispersedly distributed inhibitor can inhibit a growth of non-Goss textures during a secondary recrystallization, thereby promoting a development of Goss textures and improving a magnetic performance of the grain-oriented silicon steel.

In some embodiments, a decarburization temperature T ranges from 780° C. to 1000° C., and the decarburization temperature T and a composition of the hot-rolled strip steel satisfy the following relationship:

$$T = \frac{k 1}{Als} - \frac{k 2}{Sn + Sb + Mo} - \frac{k 3}{1000 + Cu} + b$$

where Als, Sn, Sb, Mo and Cu are mass fractions of respective compositions in the hot-rolled strip steel, with a unit of ppm, k1 ranges from 28000 to 30000; k2 ranges from 9700 to 10000; k3 ranges from 4000 to 5000; and b ranges from 720 to 780. For example, in the high-magnetic-induction grain-oriented silicon steel, a content of Als is 270 ppm; a content of Sn is 400 ppm; a content of Mo is 250 ppm; and a content of Cu is 50 ppm; then T=29000/270−9800/(400+250+0)−4500/(1000+50)+757=850° C.

Controlling the decarburization temperature can ensure that a grain size after a primary recrystallization ranges from 18 μm to 30 μm, to adjust a grain boundary energy of the primary recrystallization during a high-temperature annealing, and the grain boundary energy of the primary recrystallization can serve as a driving force for the secondary recrystallization. Al and N will form an inhibitor during subsequent nitriding and high-temperature annealing, and the inhibitor formed at this stage, together with an original inhibitor and elements of a grain boundary segregation such as Sn, Sb, P, Mo and B, have an inhibitory force to inhibit a grain growth of the primary recrystallization during the high-temperature annealing. The inhibitory force and the driving force jointly determine a temperature of secondary recrystallization, that is, an abnormal growth of Goss nuclei. Both excessively high and excessively low secondary recrystallization temperatures are not conducive to the abnormal growth of Goss nuclei. Therefore, controlling the decarburization temperature and the composition of the grain-oriented silicon steel to satisfy the aforementioned relationship can ensure that the Goss nuclei grow preferentially within an appropriate temperature range, to reduce an iron loss of the grain-oriented silicon steel, and thus further improve a magnetic performance of the grain-oriented silicon steel. In addition, the grain boundary segregation not only plays a role of an auxiliary inhibitor, but also has a function of adjusting a deformation texture, further improving a magnetic performance of the grain-oriented silicon steel.

In some embodiments, the k1 ranges from 28500 to 29500; the k2 ranges from 9700 to 9900; the k3 ranges from 4000 to 5000; and the b ranges from 730 to 760.

After the nitriding, a carbon content of the strip steel is ≤30 ppm, a nitrogen content of the strip steel ranges from 150 ppm to 400 ppm, and an average grain size is 16 μm to 30 μm. In some embodiments, a nitriding temperature ranges from 700° C. to 1000° C. The nitriding temperature may range from 780° C. to 950° C. The nitriding temperature may range from 800° C. to 850° C. N in the strip steel and Als in the strip steel will form an AlN inhibitor during subsequent annealing. The AlN inhibitor can inhibit a grain growth during the primary recrystallization, thereby ensuring an abnormal growth of the Goss grains, improving a magnetic property of the grain-oriented silicon steel, and reducing an iron loss of the grain-oriented silicon steel. An excessively high nitriding temperature will cause a large amount of N element to be enriched in the surface layer to a certain extent, thereby forming a Fe—N austenite phase and hindering a further nitriding. This will lead to a growth of a primary recrystallized grain size before a formation of nitriding inhibitor, which is not conducive to an occurrence of the secondary recrystallization and reduces a magnetic performance of the grain-oriented silicon steel. An excessively low nitriding temperature will reduce a diffusion rate of nitrogen element in a matrix to a certain extent, making the nitriding difficult and uneven, and easily leading to mixed grains.

In some embodiments, an annealing may be further performed after the nitriding is completed. The annealing may be performed in an annular annealing furnace or a bell-type annealing furnace. During the annealing, a heating rate ranges from 5° C./h to 20° C./h, an annealing temperature ranges from 1170° C. to 1250° C., and a holding time is more than 3 h. During the annealing process, a soaking temperature is above 1170° C., which is referred to as high-temperature annealing in the art. During the high-temperature annealing, the inhibitor begins to be ripened or decomposed, and a pinning effect on grain boundaries begins to weaken. Due to the excessive number of Σ9 grain boundaries or high-angle grain boundaries around the Goss nuclei, the Goss nuclei grow preferentially, and further form a size advantage during the heating process, thereby causing the secondary recrystallization. During the annealing process, an excessively high heating rate will make the inhibitor have no time to be decomposed to a certain extent. Therefore, a strength of the inhibitor is still very high at a suitable temperature for an occurrence of the secondary recrystallization, and finally grains with various orientations grow at a higher temperature to form fine grains. An excessively low heating rate will not only seriously affect a production efficiency, but also allow the inhibitor to have enough time to ripened or decomposed at a relatively low temperature to a certain extent, resulting in a low temperature for the occurrence of the secondary recrystallization, and inaccurate Goss nuclei may also grow, leading to a deterioration of magnetic performance. An excessively high annealing temperature will impose higher requirements on a high temperature resistance of the equipment, and at the same time, cause an additional deterioration of strip shape during the creep of steel coil at the high temperature and a subsequent cooling process.

An excessively low annealing temperature is not conducive to a purification of N and S elements in the steel to a certain extent, resulting in a performance deterioration due to an aging effect during subsequent use of the grain-oriented silicon steel.

In a second aspect, a high-magnetic-induction grain-oriented silicon steel according to some embodiments of the disclosure is provided, which is prepared by the method for preparing the first aspect.

The high-magnetic-induction grain-oriented silicon steel may include the following chemical compositions in mass fraction: C: 0.045% to 0.075%, Si: 2.5% to 4.0%, Mn: 0.08% to 0.2%, P: 0.01% to 0.05%, S: 0.005% to 0.012%, Al: 0.025% to 0.035%, N: 0.005% to 0.0100%, Cu: 0 to 0.25%, Cr: 0.05% to 0.25%, Sn+Sb+Mo: 0.03% to 0.15%, Nb+V+Ti+B 0.015%, with the balance being Fe and inevitable inclusions.

Hereinafter, a high-magnetic-induction grain-oriented silicon steel and a preparation method thereof according to some embodiments of the disclosure will be further described in conjunction with specific examples.

### Examples 1 to 12 and Comparative Examples 1 to 10

Examples 1 to 12 and Comparative Examples 1 to 10 provide a method for preparing a high-magnetic-induction grain-oriented silicon steel. Chemical compositions of the high-magnetic-induction grain-oriented silicon steel are shown in Table 1 and Table 2, with the balance being Fe and inevitable impurities. The method for preparing the high-magnetic-induction grain-oriented silicon steel comprises the following steps.

A slab is heated, then hot rolled, and then normalized, annealed, and then pickled. A pickled strip steel is fed into a six-stand cold continuous rolling mill for a cold rolling, and after the cold rolling is completed, sequentially subjected to a decarburization and a nitriding, and finally subjected to a high-temperature annealing and a stretch leveling annealing. Process controls for each procedure are shown in Table 3 to Table 7.

### Comparative Example 11

Comparative Example 11 provides a method for preparing the high-magnetic-induction grain-oriented silicon steel. A difference between this high-magnetic-induction grain-oriented silicon steel and those of Examples 1 to 12 is in that a reversible cold rolling is performed by a twenty-high reversible rolling mill whose work-roll diameter is 100 mm. Process controls for each procedure of Comparative Example 11 are shown in Table 3 to Table 7.

### Comparative Example 12

Comparative Example 12 provides a method for preparing a high-magnetic-induction grain-oriented silicon steel. The high-magnetic-induction grain-oriented silicon steel is cold-rolled by an eighteen-high six-stand cold continuous rolling mill whose work-roll diameter is 150 mm. A composition B2 in Table 1 is adopted. A thickness of a hot-rolled coil is 2.2 mm. A finished product has a thickness of 0.216 mm, and a width of 1225 mm. More process controls are shown in Table 3 to Table 7.

TABLE 1

| Category | C/% | Si/% | Mn/% | P/% | S/% | Als/% | N/% | Cu/% | Cr/% |
|---|---|---|---|---|---|---|---|---|---|
| A1 | 0.06 | 3.4 | 0.12 | 0.027 | 0.007 | 0.027 | 0.007 | 0.005 | 0.13 |
| A2 | 0.05 | 3.3 | 0.11 | 0.026 | 0.006 | 0.028 | 0.008 | 0.018 | 0.12 |
| B1 | 0.07 | 3.1 | 0.03 | 0.027 | 0.007 | 0.025 | 0.009 | 0.005 | 0.13 |
| B2 | 0.05 | 3.2 | 0.10 | 0.015 | 0.006 | 0.026 | 0.008 | 0.004 | 0.11 |

TABLE 2

| Category | Sn/% | Mo/% | Nb/% | V/% | Ti/% | B/% | Sn + Mo/% | Nb + V + Ti + B/% |
|---|---|---|---|---|---|---|---|---|
| A1 | 0.04 | 0.025 | 0.003 | 0.002 | 0.001 | 0.0005 | 0.065 | 0.011 |
| A2 | 0.07 | 0.05 | 0.005 | 0.004 | 0.003 | 0.001 | 0.120 | 0.013 |
| B1 | 0.08 | 0.07 | 0.008 | 0.004 | 0.002 | 0.001 | 0.15 | 0.0141 |
| B2 | 0.03 | 0.02 | 0.001 | 0.001 | 0.0015 | 0.0005 | 0.050 | 0.004 |

TABLE 3

| | | Slab | Normalizing Annealing | | Surface | |
|---|---|---|---|---|---|---|
| | | Heating | Heating | Soaking | Roughness | Thickness |
| | Chemical | Temperature/ | Temperature/ | Temperature/ | After | after |
| Numeration | Compositions | ° C. | ° C. | ° C. | Pickling/μm | Pickling/mm |
| Example 1 | A1 | 1100 | 1150 | 950 | 3.0 | 2.3 |
| Example 2 | A1 | 1130 | 1120 | 930 | 2.8 | 2.6 |
| Example 3 | A1 | 1100 | 1100 | 890 | 2.7 | 2.3 |
| Example 4 | A1 | 1150 | 1170 | 920 | 3.1 | 2.6 |
| Example 5 | A1 | 1080 | 1100 | 940 | 2.6 | 2.3 |
| Example 6 | A2 | 1120 | 1050 | 930 | 3.1 | 2.6 |
| Example 7 | A2 | 1110 | 1120 | 910 | 3.2 | 2.3 |
| Example 8 | A2 | 1120 | 1080 | 970 | 3.1 | 2.6 |
| Example 9 | A2 | 1130 | 960 | 950 | 2.9 | 2.0 |
| Example 10 | A2 | 1090 | 1100 | 980 | 2.9 | 2.3 |
| Example 11 | B1 | 1110 | 1000 | 880 | 2.8 | 2.3 |
| Example 12 | B2 | 1120 | 1110 | 920 | 3.0 | 2.6 |
| Comparative | A1 | 1070 | 1100 | 840 | 2.5 | 3.5 |
| Example 1 | | | | | | |
| Comparative | A1 | 1100 | 1100 | 840 | 2.5 | 3.85 |
| Example 2 | | | | | | |
| Comparative | A1 | 1100 | 1100 | 1100 | 3.2 | 2.6 |
| Example 3 | | | | | | |
| Comparative | A1 | 1100 | 1100 | 1100 | 3.5 | 2.3 |
| Example 4 | | | | | | |
| Comparative | A1 | 1100 | 1100 | 840 | 2.8 | 2.6 |
| Example 5 | | | | | | |
| Comparative | A2 | 1060 | 1100 | 840 | 2.8 | 2.3 |
| Example 6 | | | | | | |
| Comparative | A2 | 1110 | 1100 | 1100 | 3.5 | 2.6 |
| Example 7 | | | | | | |
| Comparative | A2 | 1120 | 1100 | 850 | 2.8 | 2.3 |
| Example 8 | | | | | | |
| Comparative | A2 | 1120 | 1100 | 840 | 2.8 | 2.6 |
| Example 9 | | | | | | |
| Comparative | A2 | 1200 | 1100 | 840 | 2.5 | 2.3 |
| Example 10 | | | | | | |
| Comparative | B1 | 1110 | 1100 | 840 | 2.8 | 2.6 |
| Example 11 | | | | | | |
| Comparative | B2 | 1120 | 1110 | 1110 | 3.0 | 2.3 |
| Example 12 | | | | | | |

TABLE 4

| | Reduction Rate of Each Stand/% | | | | | | Total reduction | |
|---|---|---|---|---|---|---|---|---|
| | First | Second | Third | Fourth | Fifth | Sixth | rate of Cold | work-roll |
| Numeration | Stand | Stand | Stand | Stand | Stand | Stand | rolling/% | diameter/mm |
| Example 1 | 36.00 | 41.00 | 36.00 | 28.80 | 25.80 | 13.16 | 88.9 | 410 |
| Example 2 | 37.00 | 41.00 | 38.00 | 30.00 | 26.00 | 17.84 | 90.2 | 350 |
| Example 3 | 35.00 | 37.60 | 32.00 | 28.80 | 25.80 | 34.35 | 90.43 | 340 |
| Example 4 | 38.00 | 41.00 | 39.00 | 33.00 | 29.00 | 20.28 | 91.54 | 340 |
| Example 5 | 35.00 | 36.00 | 36.00 | 29.40 | 24.00 | 13.26 | 87.61 | 460 |
| Example 6 | 36.50 | 38.60 | 36.00 | 29.40 | 24.00 | 18.13 | 89.04 | 430 |
| Example 7 | 36.00 | 41.00 | 36.00 | 28.80 | 25.80 | 13.16 | 88.9 | 450 |
| Example 8 | 37.00 | 41.00 | 38.00 | 30.00 | 26.00 | 17.84 | 90.2 | 360 |
| Example 9 | 35.00 | 37.60 | 32.00 | 28.80 | 25.80 | 34.80 | 90.50 | 350 |
| Example 10 | 39.00 | 42.00 | 43.00 | 35.00 | 36.00 | 1.53 | 91.74 | 340 |
| Example 11 | 36.00 | 41.00 | 36.00 | 28.80 | 25.80 | 13.16 | 88.9 | 480 |
| Example 12 | 37.00 | 41.00 | 38.00 | 30.00 | 26.00 | 17.84 | 90.2 | 350 |
| Comparative | 41.00 | 42.00 | 43.00 | 35.00 | 36.00 | 22.53 | 93.71 | 350 |
| Example 1 | | | | | | | | |
| Comparative | 42.00 | 41.00 | 43.00 | 36.00 | 36.00 | 28.48 | 94.29 | 340 |
| Example 2 | | | | | | | | |
| Comparative | 35.50 | 37.50 | 35.80 | 29.40 | 24.00 | 10.77 | 87.61 | 500 |
| Example 3 | | | | | | | | |
| Comparative | 32.00 | 32.00 | 33.00 | 29.40 | 24.00 | 14.28 | 85.75 | 510 |
| Example 4 | | | | | | | | |
| Comparative | 32.00 | 30.00 | 30.00 | 28.00 | 24.00 | 4.02 | 82.50 | 520 |
| Example 5 | | | | | | | | |
| Comparative | 41.00 | 42.00 | 43.00 | 35.00 | 36.00 | 22.53 | 93.71 | 320 |
| Example 6 | | | | | | | | |
| Comparative | 42.00 | 41.00 | 43.00 | 36.00 | 36.00 | 28.48 | 94.29 | 310 |
| Example 7 | | | | | | | | |
| Comparative | 35.50 | 37.50 | 35.80 | 29.40 | 24.00 | 10.77 | 87.61 | 500 |
| Example 8 | | | | | | | | |
| Comparative | 32.00 | 32.00 | 33.00 | 29.40 | 24.00 | 14.28 | 85.75 | 510 |
| Example 9 | | | | | | | | |
| Comparative | 32.00 | 30.00 | 30.00 | 28.00 | 24.00 | 4.02 | 82.50 | 520 |
| Example 10 | | | | | | | | |
| Comparative | 37.00 | 41.00 | 38.00 | 30.00 | 26.00 | 17.84 | 90.2 | 110 |
| Example 11 | | | | | | | | |
| Comparative | 37.50 | 35.00 | 34.00 | 32.00 | 28.00 | 25.20 | 90.2 | 160 |
| Example 12 | | | | | | | | |

TABLE 5

| | | | | | | | Output | |
|---|---|---|---|---|---|---|---|---|
| | | | | | | | Speed of | |
| | | | | | | | cold | Cold |
| | Surface roughness of work roll of each stand/μm | | | | | | continuous | Rolling |
| | First | Second | Third | Fourth | Fifth | Sixth | rolling | Temperature/ |
| Numeration | Stand | Stand | Stand | Stand | Stand | Stand | mill/mpm | ° C. |
| Example 1 | 0.45 | 0.45 | 0.45 | 0.4 | 0.25 | 0.21 | 800 | 260 |
| Example 2 | 0.50 | 0.50 | 0.46 | 0.4 | 0.29 | 0.22 | 1000 | 280 |
| Example 3 | 0.52 | 0.48 | 0.48 | 0.42 | 0.25 | 0.28 | 400 | 80 |
| Example 4 | 0.55 | 0.50 | 0.48 | 0.42 | 0.28 | 0.30 | 600 | 120 |
| Example 5 | 0.45 | 0.45 | 0.45 | 0.42 | 0.25 | 0.32 | 1200 | 260 |
| Example 6 | 0.52 | 0.48 | 0.48 | 0.42 | 0.25 | 0.28 | 1000 | 240 |
| Example 7 | 0.55 | 0.50 | 0.48 | 0.40 | 0.28 | 0.30 | 800 | 240 |
| Example 8 | 0.52 | 0.48 | 0.48 | 0.42 | 0.25 | 0.28 | 1000 | 280 |
| Example 9 | 0.75 | 0.60 | 0.58 | 0.43 | 0.28 | 0.30 | 300 | 100 |
| Example 10 | 0.76 | 0.68 | 0.58 | 0.42 | 0.25 | 0.22 | 800 | 200 |
| Example 11 | 0.65 | 0.50 | 0.48 | 0.41 | 0.24 | 0.30 | 1000 | 220 |
| Example 12 | 0.62 | 0.48 | 0.48 | 0.42 | 0.21 | 0.28 | 1100 | 230 |
| Comparative | 0.78 | 0.78 | 0.62 | 0.52 | 0.42 | 0.42 | 500 | 70 |
| Example 1 | | | | | | | | |
| Comparative | 0.52 | 0.48 | 0.48 | 0.42 | 0.25 | 0.28 | 600 | 90 |
| Example 2 | | | | | | | | |
| Comparative | 0.55 | 0.50 | 0.48 | 0.40 | 0.28 | 0.30 | 600 | 70 |
| Example 3 | | | | | | | | |
| Comparative | 0.52 | 0.48 | 0.48 | 0.42 | 0.25 | 0.28 | 800 | 180 |
| Example 4 | | | | | | | | |
| Comparative | 0.75 | 0.60 | 0.58 | 0.43 | 0.28 | 0.30 | 900 | 200 |
| Example 5 | | | | | | | | |
| Comparative | 0.76 | 0.68 | 0.58 | 0.42 | 0.25 | 0.22 | 700 | 190 |
| Example 6 | | | | | | | | |
| Comparative | 0.78 | 0.78 | 0.62 | 0.52 | 0.42 | 0.42 | 800 | 200 |
| Example 7 | | | | | | | | |
| Comparative | 0.55 | 0.50 | 0.48 | 0.40 | 0.28 | 0.30 | 600 | 170 |
| Example 8 | | | | | | | | |
| Comparative | 0.52 | 0.48 | 0.48 | 0.42 | 0.25 | 0.28 | 500 | 110 |
| Example 9 | | | | | | | | |
| Comparative | 0.55 | 0.50 | 0.48 | 0.40 | 0.28 | 0.30 | 800 | 200 |
| Example 10 | | | | | | | | |
| Comparative | 0.50 | 0.50 | 0.46 | 0.4 | 0.29 | 0.22 | 800 | 220 |
| Example 11 | | | | | | | | |
| Comparative | 0.85 | 0.80 | 0.70 | 0.60 | 0.45 | 0.25 | 700 | 225 |
| Example 12 | | | | | | | | |

TABLE 6

| Numeration | k1 | k2 | k3 | b |
|---|---|---|---|---|
| Example 1 | 29000 | 9800 | 4500 | 761 |
| Example 2 | 29500 | 9980 | 4900 | 750 |
| Example 3 | 28000 | 9900 | 4980 | 765 |
| Example 4 | 28100 | 9780 | 4700 | 745 |
| Example 5 | 29300 | 9900 | 4800 | 740 |
| Example 6 | 29000 | 9800 | 4500 | 758 |
| Example 7 | 28800 | 10000 | 5000 | 749 |
| Example 8 | 28000 | 9800 | 4500 | 762 |
| Example 9 | 28000 | 9700 | 4200 | 731 |
| Example 10 | 29000 | 9800 | 4500 | 758 |
| Example 11 | 30000 | 9700 | 4000 | 730 |
| Example 12 | 28000 | 9900 | 4600 | 755 |
| Comparative | 26000 | 9800 | 4500 | 742 |
| Example 1 | | | | |
| Comparative | 25000 | 10000 | 5000 | 677 |
| Example 2 | | | | |
| Comparative | 22000 | 12500 | 5600 | 722 |
| Example 3 | | | | |
| Comparative | 28100 | 7000 | 5000 | 721 |
| Example 4 | | | | |
| Comparative | 18000 | 9900 | 4800 | 722 |
| Example 5 | | | | |
| Comparative | 28000 | 9700 | 4200 | 731 |
| Example 6 | | | | |
| Comparative | 22000 | 10000 | 5500 | 684 |
| Example 7 | | | | |
| Comparative | 22000 | 12500 | 5600 | 716 |
| Example 8 | | | | |
| Comparative | 27000 | 9700 | 4200 | 725 |
| Example 9 | | | | |
| Comparative | 19000 | 12000 | 6500 | 717 |
| Example 10 | | | | |
| Comparative | 30000 | 9700 | 4000 | 730 |
| Example 11 | | | | |
| Comparative | 29300 | 9900 | 4800 | 740 |
| Example 12 | | | | |

TABLE 7

| | | | | | | Thickness | Width |
|---|---|---|---|---|---|---|---|
| | | | | | | of | of |
| | Decarburization | Carbon | Grain | | High- | Finishing | Finished |
| | and | Content | Size | | Temperature | grain- | grain- |
| | Nitriding | after | after | | Annealing | oriented | oriented |
| | Temperature/ | Decarburization/ | Decarburization/ | Nitriding | Temperature/ | silicon | silicon |
| Numeration | ° C. | ppm | μm | Amount/ppm | ° C. | steel/mm | steel/mm |
| Example 1 | 850 | 12 | 28 | 220 | 1200 | 0.255 | 1225 |
| Example 2 | 840 | 15 | 26 | 230 | 1190 | 0.255 | 1225 |
| Example 3 | 850 | 13 | 27 | 210 | 1210 | 0.220 | 1225 |
| Example 4 | 830 | 9 | 20 | 240 | 1180 | 0.220 | 1225 |
| Example 5 | 830 | 8 | 22 | 220 | 1240 | 0.285 | 1225 |
| Example 6 | 850 | 7 | 26 | 220 | 1200 | 0.285 | 1225 |
| Example 7 | 840 | 12 | 25 | 230 | 1190 | 0.255 | 1225 |
| Example 8 | 850 | 15 | 29 | 210 | 1210 | 0.255 | 1225 |
| Example 9 | 820 | 16 | 20 | 240 | 1180 | 0.190 | 1225 |
| Example 10 | 850 | 18 | 26 | 22 | 1240 | 0.190 | 1225 |
| Example 11 | 840 | 16 | 24 | 220 | 1200 | 0.255 | 1225 |
| Example 12 | 840 | 14 | 28 | 210 | 1210 | 0.255 | 1225 |
| Comparative | 820 | 22 | 20 | 280 | 1200 | 0.220 | 1225 |
| Example 1 | | | | | | | |
| Comparative | 750 | 35 | 15 | 310 | 1160 | 0.220 | 1225 |
| Example 2 | | | | | | | |
| Comparative | 780 | 25 | 18 | 300 | 1180 | 0.322 | 1225 |
| Example 3 | | | | | | | |
| Comparative | 810 | 19 | 20 | 150 | 1170 | 0.328 | 1225 |
| Example 4 | | | | | | | |
| Comparative | 770 | 22 | 18 | 160 | 1150 | 0.455 | 1225 |
| Example 5 | | | | | | | |
| Comparative | 820 | 20 | 23 | 280 | 1200 | 0.145 | 1225 |
| Example 6 | | | | | | | |
| Comparative | 750 | 31 | 18 | 310 | 1160 | 0.148 | 1225 |
| Example 7 | | | | | | | |
| Comparative | 780 | 26 | 19 | 300 | 1180 | 0.285 | 1225 |
| Example 8 | | | | | | | |
| Comparative | 810 | 21 | 21 | 150 | 1170 | 0.371 | 1225 |
| Example 9 | | | | | | | |
| Comparative | 770 | 30 | 20 | 160 | 1150 | 0.403 | 1225 |
| Example 10 | | | | | | | |
| Comparative | 840 | 128 | 26 | 220 | 1200 | 0.255 | 1225 |
| Example 11 | | | | | | | |
| Comparative | 830 | 21 | 28 | 210 | 1200 | 0.216 | 1225 |
| Example 12 | | | | | | | |

TABLE 8

| Numeration | P1.7 / W/kg | B8 / T | Roll Change Cycle / t |
|---|---|---|---|
| Example 1 | 0.78 | 1.94 | 5000 |
| Example 2 | 0.8 | 1.93 | 4800 |
| Example 3 | 0.71 | 1.94 | 4500 |
| Example 4 | 0.75 | 1.91 | 4800 |
| Example 5 | 0.98 | 1.92 | 4800 |
| Example 6 | 0.96 | 1.93 | 5200 |
| Example 7 | 0.79 | 1.94 | 5000 |
| Example 8 | 0.82 | 1.92 | 5000 |
| Example 9 | 0.67 | 1.92 | 3600 |
| Example 10 | 0.66 | 1.91 | 4200 |
| Example 11 | 0.84 | 1.90 | 4200 |
| Example 12 | 0.83 | 1.91 | 4800 |
| Comparative Example 1 | 0.96 | 1.87 | 4800 |
| Comparative Example 2 | 1.02 | 1.85 | 4800 |
| Comparative Example 3 | 1.35 | 1.83 | 5200 |
| Comparative Example 4 | 1.4 | 1.83 | 5200 |
| Comparative Example 5 | 2.1 | 1.78 | 4800 |
| Comparative Example 6 | 1.01 | 1.87 | 3600 |
| Comparative Example 7 | 1.05 | 1.85 | 3600 |
| Comparative Example 8 | 1.45 | 1.83 | 5400 |
| Comparative Example 9 | 1.48 | 1.83 | 5400 |
| Comparative Example 10 | 1.92 | 1.78 | 5800 |
| Comparative Example 11 | 0.85 | 1.9 | 60 |
| Comparative Example 12 | 0.85 | 1.88 | 2800 |

The roll change cycle refers to a weight of the grain-oriented silicon steel rolled by a set of work rolls. For example, a roll change cycle of 1000 t means that a set of work rolls are replaced after the set of work rolls has rolled 1000 t of the grain-oriented silicon steel.

The grain-oriented silicon steel prepared in Examples 1 to 12 and Comparative Examples 1 to 12 is sampled and detected for an iron loss and a magnetic induction, and the roll change cycle was recorded. Results are shown in Table 8.

It can be seen from the data in Table 8 that the grain-oriented silicon steel obtained by the methods of Examples 1 to 12 of the disclosure has a low iron loss P1.7 ranging from 0.66 W/kg to 0.98 W/kg, a high magnetic induction intensity B8 (1B800) ranging from 1.90 T to 1.94 T, and a long roll change cycle ranging from 3600 t to 5200 t and a high production efficiency.

The grain-oriented silicon steel obtained by the methods provided in Comparative Examples 1 to 10 has a P1.7 ranging from 0.96 W/kg to 2.1 W/kg, a B8 ranging from 1.78 T to 1.87 T, and a roll change cycle ranging from 3600 t to 5800 t.

In comparative Example 11, a conventional twenty-high reversible rolling mill is adopted for rolling, and the grain-oriented silicon steel obtained by this method has a P1.7 of 0.85 W/kg, a B8 of 1.9 T, and a roll change cycle of 60 t. Since an iron loss is related to a thickness of the grain-oriented silicon steel, generally speaking, the thicker the thickness is, the greater the iron loss is; and the thinner the thickness is, the smaller the iron loss is. A thickness of the grain-oriented silicon steel in Comparative Example 11 is 0.255 mm, and thicknesses of the grain-oriented silicon steels in Example 1, Example 2, Example 7, Example 8, Example 11 and Example 12 of the disclosure are also 0.255 mm. The iron losses of the grain-oriented silicon steels in Examples 1, 2, 7, 8, 11, and 12 of the disclosure are 0.78 W/kg, 0.8 W/kg, 0.79 W/kg, 0.82 W/kg, 0.84 W/kg, and 0.83 W/kg, respectively, all of which are lower than 0.85 W/kg of Comparative Example 11. Therefore, the iron loss of the grain-oriented silicon steel of some embodiments of the disclosure is lower than that of Comparative Example 11. Moreover, the magnetic inductions B8 of the grain-oriented silicon steels of Examples 1 to 12 of the disclosure is 1.90 T to 1.94 T, which is not lower than that of Comparative Example 11. Therefore, the magnetic induction of the grain-oriented silicon steel obtained by the embodiments of the disclosure is partially equal to that of the twenty-high reversible rolling mill, and partially higher than that of the twenty-high reversible rolling mill. Moreover, the roll change cycle of the disclosure is longer than that of Comparative Example 11, resulting in a higher production efficiency.

Comparative Example 12 adopts an eighteen-high six-stand cold continuous rolling mill for cold continuous rolling, with a work-roll diameter of 150 mm, which is smaller than a work-roll diameter of the six-stand mill of the disclosure. The grain-oriented silicon steel obtained by this method has a P1.7 of 0.85 W/kg, a B8 of 1.88 T, and a roll change cycle of 2800 t. A thickness of the grain-oriented silicon steel in Comparative Example 12 is 0.216 mm, and a thickness of grain-oriented silicon steel in actual rolling is mostly 0.17 mm, 0.19 mm, 0.22 mm, 0.255 mm and 0.285 mm. A thickness of the grain-oriented silicon steel in Example 1, Example 2, Example 7, Example 8, Example 11 and Example 12 of the disclosure is all 0.255 mm, and a thickness of the grain-oriented silicon steel in Example 3 and Example 4 is all 0.220 mm, which are all greater than the thickness of the grain-oriented silicon steel in Comparative Example 12. Iron losses of the grain-oriented silicon steels in Example 1, Example 2, Example 7, Example 8, Example 11 and Example 12 of the disclosure are 0.78 W/kg, 0.8 W/kg, 0.79 W/kg, 0.82 W/kg, 0.84 W/kg, and 0.83 W/kg, respectively, all of which are lower than 0.85 W/kg of Comparative Example 11. The iron losses of the grain-oriented silicon steels in Example 3 and Example 4 of the disclosure are 0.71 W/kg and 0.75 W/kg respectively. Therefore, under the premise that the thickness of the grain-oriented silicon steel of the embodiments of the disclosure is greater than that of Comparative Example 12, the iron loss of the grain-oriented silicon steel of the embodiments of the disclosure is still lower than that of Comparative Example 12. The embodiments of the disclosure achieve an unexpected technical effect. Moreover, the magnetic induction B8 of the grain-oriented silicon steel in Examples 1 to 12 of the disclosure is 1.90 T to 1.94 T, and the magnetic induction B8 of the grain-oriented silicon steels in Example 3 and Example 4 of the disclosure is 1.91 T to 1.94 T, which are all greater than a magnetic induction of 1.88 T of the grain-oriented silicon steel in Comparative Example 12. It can be seen from the above that, compared with a cold continuous rolling mill with a small-sized work roll, the grain-oriented silicon steel prepared by the method for preparing grain-oriented silicon steel of some embodiments of the disclosure has more excellent magnetic induction and iron loss.

In one or more embodiments, Comparative Example 12 adopts a cold continuous rolling mill with small-diameter work rolls with a roll change cycle of 2800 t, which is less than 3600 t to 5200 t of Examples 1 to 12 of the disclosure, and a service life of the work rolls in Comparative Example 12 is lower than that in the embodiments of the disclosure.

Advantageous effects of the disclosure at least include:

A method for preparing a high-magnetic-induction grain-oriented silicon steel according to some embodiments of the disclosure comprises the following steps: heating a hot-rolled strip steel and then subjecting the same to a cold continuous rolling by using a cold continuous rolling mill with work-roll diameters ranging from 300 mm to 500 mm, to obtain a cold continuous rolled strip steel; and sequentially subjecting the cold continuous rolled strip steel to a decarburization and nitriding, to obtain the high-magnetic-induction grain-oriented silicon steel. In the disclosure, a cold continuous rolling with large-diameter work rolls is adopted. Since a work-roll diameter of the cold continuous rolling is more than 3 times that of a conventional twenty-high reversible rolling mill, a rolling deformation zone is closer to flat rolling, so that a deformation of the surface layer and near-surface layer of the strip steel is closer to a compression deformation, so that a large amount of shear deformation is formed in a central layer of the strip steel. The shear deformation in the central layer serves as nucleation sites to facilitate a primary recrystallization, so that the total amount of Goss grains in a thickness direction of the strip steel is increased. Thus, a growth of other grains can be inhibited during secondary recrystallization, so that a grain size of the grain-oriented silicon steel is relatively small, while the Goss grains can grow up, thereby improving a magnetic performance of the grain-oriented silicon steel. The grain-oriented silicon steel obtained by the method for preparing some embodiments of the disclosure has an iron loss P1.7 ranging from 0.66 W/kg to 0.98 W/kg, a low iron loss B8 ranging from 1.90 T to 1.94 T, a high magnetic induction, an excellent magnetic performance, and a long roll change cycle ranging from 3600 t to 5200 t and a high production efficiency.

In the method for preparing a high-magnetic-induction grain-oriented silicon steel according to some embodiments of the disclosure, the high-magnetic-induction grain-oriented silicon steel is cold-rolled to a finished thickness in one pass by a cold continuous rolling mill with work rolls whose diameters are 2 to 4 times that of the work rolls of a conventional twenty-high reversible rolling mill. A deformation zone is closer to flat rolling, increasing a shear deformation of the central layer of the strip steel, and the shear deformation serves as nucleation sites to increase the number of Goss grains, so that a grain size of the grain-oriented silicon steel is relatively small, while the Goss grains can grow up, thereby improving an electromagnetic performance of the grain-oriented silicon steel. In the disclosure, the compositions are matched with the decarburization annealing temperature, so that the primary recrystallization occurs at an appropriate temperature and an appropriate grain size is achieved, a driving force and an inhibitory force of secondary recrystallization are matched, and the growth of Goss grains occurs in the optimal secondary recrystallization temperature range, further improving a magnetic performance of the high-magnetic-induction grain-oriented silicon steel. Meanwhile, compared with a reversible rolling mill, inherent acceleration and deceleration processes of the rolling speed from zero to a maximum speed for each pass are avoided, a rolling process is more stable, and a strip shape and a thickness control accuracy of the finished grain-oriented silicon steel are further improved. The grain-oriented silicon steel obtained by the method for preparing some embodiments of the disclosure has an iron loss P1.7 ranging from 0.66 W/kg to 0.98 W/kg, a B8 ranging from 1.90 T to 1.94 T with a low iron loss, a high magnetic induction with an excellent magnetic performance, and a roll change cycle ranging from 3600 t to 5200 t with a long roll change cycle and a high production efficiency.

Although the preferred embodiments of the disclosure have been described, those of ordinary skill in the art can make additional changes and modifications to these embodiments once they learn the basic inventive concept. Therefore, the appended claims are intended to be construed to include the preferred embodiments and all changes and modifications that fall within the scope of the disclosure.

Obviously, those skilled in the art can make various changes and modifications to the disclosure without departing from the spirit and scope of the disclosure. Thus, if these modifications and variations of the disclosure fall within the scope of the claims of the disclosure and the equivalent technologies thereof, the disclosure is also intended to include these changes and modifications.

What is claimed is:

1. A method for preparing a high-magnetic-induction grain-oriented silicon steel, comprising:
heating a hot-rolled strip steel, followed by cold continuous rolling by using a cold continuous rolling mill with a work-roll diameter ranging from 300 mm to 500 mm, to obtain a cold continuous rolled strip steel; and
sequentially decarburizing and nitriding the cold continuous rolled strip steel, to obtain the high-magnetic-induction grain-oriented silicon steel.

2. The method for preparing the high-magnetic-induction grain-oriented silicon steel according to claim 1, wherein a decarburization temperature T ranges from 780° C. to 1000° C., the decarburization temperature T and compositions of the hot-rolled strip steel satisfying the following relationship:
$$T = \frac{k 1}{Als} - \frac{k 2}{Sn + Sb + Mo} - \frac{k 3}{1000 + Cu} + b$$
where Als, Sn, Sb, Mo and Cu are mass fractions of respective chemical compositions in the hot-rolled strip steel, k1 ranging from 28000 to 30000, k2 ranging from 9700 to 10000, k3 ranging from 4000 to 5000, and b ranging from 720 to 780.

3. The method for preparing the high-magnetic-induction grain-oriented silicon steel according to claim 2, wherein the k1 ranges from 28500 to 29500, the k2 ranging from 9700 to 9900, the b ranging from 730 to 760.

4. The method for preparing the high-magnetic-induction grain-oriented silicon steel according to claim 1, wherein a total reduction rate of the cold continuous rolling ranges from 85% to 92%.

5. The method for preparing the high-magnetic-induction grain-oriented silicon steel according to claim 2, wherein a total reduction rate of the cold continuous rolling ranges from 85% to 92%.

6. The method for preparing the high-magnetic-induction grain-oriented silicon steel according to claim 3, wherein a total reduction rate of the cold continuous rolling ranges from 85% to 92%.

7. The method for preparing the high-magnetic-induction grain-oriented silicon steel according to claim 4, wherein a rolling speed of the cold continuous rolling ranges from 300 mpm to 1200 mpm.

8. The method for preparing the high-magnetic-induction grain-oriented silicon steel according to claim 4, wherein a rolling temperature of the cold continuous rolling ranges from 70° C. to 300° C.

9. The method for preparing the high-magnetic-induction grain-oriented silicon steel according to claim 1, wherein a surface roughness of work rolls of the cold continuous rolling mill range from 0.1 μm to 0.8 μm.

10. The method for preparing the high-magnetic-induction grain-oriented silicon steel according to claim 2, wherein a surface roughness of work rolls of the cold continuous rolling mill range from 0.1 μm to 0.8 μm.

11. The method for preparing the high-magnetic-induction grain-oriented silicon steel according to claim 3, wherein a surface roughness of work rolls of the cold continuous rolling mill range from 0.1 μm to 0.8 μm.

12. The method for preparing the high-magnetic-induction grain-oriented silicon steel according to claim 1, wherein the hot-rolled strip steel is a strip steel after a normalizing treatment; in the normalizing treatment, a heating temperature of the strip steel ranges from 950° C. to 1200° C., a soaking temperature of the strip steel ranging from 850° C. to 1000° C.

13. The method for preparing the high-magnetic-induction grain-oriented silicon steel according to claim 2, wherein the hot-rolled strip steel is a strip steel after a normalizing treatment; in the normalizing treatment, a heating temperature of the strip steel ranges from 950° C. to 1200° C., a soaking temperature of the strip steel ranging from 850° C. to 1000° C.

14. The method for preparing the high-magnetic-induction grain-oriented silicon steel according to claim 3, wherein the hot-rolled strip steel is a strip steel after a normalizing treatment; in the normalizing treatment, a heating temperature of the strip steel ranges from 950° C. to 1200° C., a soaking temperature of the strip steel ranging from 850° C. to 1000° C.

15. The method for preparing the high-magnetic-induction grain-oriented silicon steel according to claim 1, wherein a nitriding temperature ranges from 700° C. to 1000° C.

16. The method for preparing the high-magnetic-induction grain-oriented silicon steel according to claim 2, wherein a nitriding temperature ranges from 700° C. to 1000° C.

17. The method for preparing the high-magnetic-induction grain-oriented silicon steel according to claim 3, wherein a nitriding temperature ranges from 700° C. to 1000° C.

18. A high-magnetic-induction grain-oriented silicon steel, prepared by the method according to claim 1.

19. The high-magnetic-induction grain-oriented silicon steel according to claim 18, wherein the high-magnetic-induction grain-oriented silicon steel comprises the following chemical components in mass fraction: C: 0.045% to 0.075%, Si: 2.5% to 4.0%, Mn: 0.08% to 0.2%, P: 0.01% to 0.05%, S: 0.005% to 0.012%, Al: 0.025% to 0.035%, N: 0.005% to 0.0100%, Cu: 0 to 0.25%, Cr: 0.05% to 0.25%, Sn+Sb+Mo: 0.03% to 0.15%, Nb+V+Ti+B≤0.015%, with the balance being Fe and inevitable inclusions.
